(19) United States
(12) Patent Application Publication
(10) Pub. No.: US 2026/0308310 A1
(43) Pub. Date: Oct. 8, 2026

(54) PELLET AND PRODUCTION METHOD THEREFOR

(71) Applicant: SUMITOMO CHEMICAL COMPANY, LIMITED, Tokyo (JP)

(72) Inventors: Yukina YAMASHITA TSUNEDA, Ibaraki (JP); Hidehiro KOTAKA, Ibaraki (JP)

(21) Appl. No.: 19/481,407

(22) PCT Filed: May 13, 2024
(86) PCT No.: PCT/JP2024/017701

§ 371 Date: Nov. 4, 2025

(30) Foreign Application Priority Data
May 31, 2023 (JP) 2023-089902

(51) Int. Cl. C08G 63/06; C08J 3/20; C08K 7/14

(52) U.S. Cl. CPC C08G 63/065; C08J 3/201; C08K 7/14; C08J 2367/04

(57) ABSTRACT

A pellet including a liquid crystal polyester and a fibrous filler (A), in which a ratio (N₁/C₁) of the number of spots per unit area N₁ (/mm²), which are derived from the fibrous filler (A) and observed in a cross section perpendicular, to the extrusion direction of the pellet to a content rate C₁ of the fibrous filler (A) is 3,500 or more and 20,000 or less.

### TECHNICAL FIELD

The present disclosure relates to a pellet and production method therefor.

### BACKGROUND ART

A liquid crystal polyester has been used in a variety of applications due to its high flowability, heat resistance, and dimensional accuracy.

A liquid crystal polyester has been typically used in the form of a liquid crystal polyester composition comprising a filler and the like to satisfy the properties required for each application, and for example, Patent Literature 1 discloses a liquid crystal polyester composition compounded with a glass fiber having a non-circular cross sectional shape.

### CITATION LIST

### Patent Literature

Patent Literature 1: Japanese Patent Laid-Open No. 2008-013703

### SUMMARY OF INVENTION

### Problems to be Solved by Invention

However, conventional liquid crystal polyester compositions have the problem of generating a trace amount of gas from a surface of a molded product in an elevated-temperature environment.

An object of the present disclosure is to provide a pellet comprising a liquid crystal polyester that can be used to form a molded product in which generation of gas (particularly high-boiling-point component) has been inhibited in an elevated-temperature environment. Another object of the present disclosure is to provide a method for producing the pellet.

### Means to Solve the Problems

The present disclosure provides the following items, for example.
[1] A pellet comprising a liquid crystal polyester and a fibrous filler (A),
   wherein a ratio (N₁/C₁) of the number of spots per unit area N₁ (/mm²), which are derived from the fibrous filler (A) and observed in a cross section perpendicular to the extrusion direction of the pellet, to a content rate C₁ of the fibrous filler (A) is 3,500 or more and 20,000 or less.
[2] The pellet according to [1], wherein the content rate C₁ of the fibrous filler (A) is 0.05 or more and 0.40 or less.
[3] The pellet according to [1] or [2], wherein an average value of circle-equivalent diameter of the spot is 9 μm or more and 13 μm or less.
[4] The pellet according to any one of [1] to [3], wherein the fibrous filler (A) comprises a glass fiber.
[5] The pellet according to any one of [1] to [4], wherein the liquid crystal polyester comprises a monomer unit derived from an aromatic hydroxycarboxylic acid.
[6] The pellet according to [5], wherein a content of the monomer unit is 50 mol % or more based on a total of all monomer units constituting the liquid crystal polyester.
[7] A method for producing a pellet, comprising a step of melt-kneading a liquid crystal polyester and a fibrous filler and forming the mixture to obtain a pellet,
   wherein the step is a step of carrying out the melt-kneading and forming so that a ratio (N₁/C₁) of the number of spots per unit area N₁ (/mm²), which are derived from the fibrous filler (A) and observed in a cross section perpendicular to the extrusion direction of the pellet, to a content rate C₁ of the fibrous filler (A) in the pellet is 3,500 or more and 20,000 or less.

### Effects of Invention

According to the present disclosure, it is possible to provide a pellet comprising a liquid crystal polyester that can be used to form a molded product in which generation of gas (particularly high-boiling point component) is inhibited in an elevated-temperature environment. Moreover, according to the present disclosure, it is possible to provide a method for producing the pellet.

### EMBODIMENTS FOR CARRYING OUT INVENTION

Hereinafter, preferred embodiments of the present disclosure will be described in detail.

The pellet of the present embodiment (hereinafter simply referred to as “pellet”) comprises a liquid crystal polyester and a fibrous filler (A). In the present embodiment, the ratio (N₁/C₁) of the number of spots per unit area N₁ (/mm²), which are derived from the fibrous filler (A) and observed in a cross section perpendicular to the extrusion direction of the pellet, to the content rate C₁ of the fibrous filler (A) is 3,500 or more and 20,000 or less.

It is to be noted that the content rate C₁ of the fibrous filler (A) as used herein can be said to be the ratio of the total mass of the fibrous filler (A) to the total mass of the pellet.

According to the pellet of the present embodiment, a molded product can be formed, in which generation of gas (particularly high-boiling point component) is inhibited in an elevated-temperature environment.

The reason for this effect produced is considered to be as follows:
Fibrous fillers aggregated within a pellet are observed as a single spot on a cross section of the pellet. In other words, the large ratio (N₁/C₁) means that the fibrous fillers are more opened and more dispersed within the pellet, while the small ratio (N₁/C₁) means that the fibrous fillers are more aggregated within the pellet. The pellet of the present embodiment has a sufficiently large ratio (N₁/C₁), indicating that the fibrous fillers can be said to be sufficiently opened within the pellet.

Since the fibrous fillers in the pellet of the present embodiment are sufficiently opened, an end of the fibrous filler is likely to be exposed on a surface of a molded product. The exposure of the end of the fibrous filler facilitates a gas component (particularly high-boiling point component) inside the molded product to be volatilized and discharged therefrom due to heating upon molding. In other words, a molded product formed of the pellet of the present embodiment is considered to generate less gas in an elevated-temperature environment because a component that causes gas generation has preliminarily been removed by heating upon molding.

Also it can be said that the pellet of the present embodiment is such that a binder contained in a fiber bundle of the fibrous fillers has been sufficiently thermally decomposed upon production of the pellet, allowing the fibers to be opened and dispersed well in a resin. Therefore, the pellet of the present embodiment inhibits generation of gas resulting from the remaining binder.

Hereinafter, each component contained in the pellet will be described in detail.

### (1) Liquid Crystal Polyester

The liquid crystal polyester may be a polyester that exhibits a liquid crystalline nature in a molten state. The pellet may contain a single liquid crystal polyester, or may contain two or more thereof.

A flow starting temperature of the liquid crystal polyester may be 250° C. or higher and may alternatively be 270° C. or higher. Also, the flow starting temperature of the liquid crystal polyester may be 400° C. or lower and may be alternatively 360° C. or lower or 340° C. or lower.

That is, the flow starting temperature of the liquid crystal polyester may be, for example, 250° C. or higher and 400° C. or lower, 250° C. or higher and 360° C. or lower, 250° C. or higher and 340° C. or lower, 270° C. or higher and 400° C. or lower, 270° C. or higher and 360° C. or lower, or 270° C. or higher and 340° C. or lower.

In the present description, the flow starting temperature of the liquid crystal polyester is measured using a flow tester and is a temperature at which the liquid crystal polyester is melted under a load of 9.8 MPa (100 kg/cm²) while being raised at a rate of 4° C./min, and the molten liquid crystal polyester that has a viscosity of 4,800 Pa·s (48,000 poise) is extruded through a nozzle with an inner diameter of 1 mm and a length of 10 mm.

The liquid crystal polyester has a constituent unit (also referred to as a monomer unit) derived from a raw material monomer. The main monomer unit of the liquid crystal polyester (the amount of monomer unit is, for example, 90 mol % or more, 95 mol % or more, or 99 mol % or more of the total monomer unit, and is preferably the total monomer unit) may be alternatively derived from an aromatic compound. A liquid crystal polyester in which all monomer units are derived from an aromatic compound is also referred to as a fully aromatic liquid crystal polyester.

Typical examples of the liquid crystal polyester include a polymer having a monomer unit derived from an aromatic hydroxycarboxylic acid (preferably a polymer having two or more monomer units derived from an aromatic hydroxycarboxylic acid), a polymer having a monomer unit derived from an aromatic dicarboxylic acid and a monomer unit derived from an aromatic diol, and a polymer having a monomer unit derived from an aromatic hydroxycarboxylic acid, a monomer unit derived from an aromatic dicarboxylic acid, and a monomer unit derived from an aromatic diol.

An example of the monomer unit derived from an aromatic hydroxycarboxylic acid includes a monomer unit represented by the following formula (I). An example of the monomer unit derived from an aromatic dicarboxylic acid includes a monomer unit represented by the following formula (II). An example of the monomer unit derived from an aromatic diol includes a monomer unit represented by the following formula (III) (provided that X and Y are oxygen atoms).

In the present description, the term “derived” means that, in a monomer unit of a liquid crystal polyester formed by polymerization of raw material monomer, the chemical structure of a functional group that contributes to polymerization in the raw material monomer has been changed, and no other changes in structure have occurred. The term “derived” as used herein is a concept also encompassing the case where the monomer unit is derived from a polymerizable derivative of the raw material monomer (for example, a compound formed by converting a functional group that contributes to polymerization in the raw material monomer into other polymerizable groups).

The liquid crystal polyester may have a monomer unit represented by the following formula (I) (hereinafter also referred to as “monomer unit (I)”) with the proviso that CO as used herein in the formula below represents a carbonyl group:

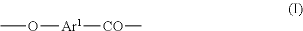

[wherein, for example, Ar¹ represents a phenylene group, a naphthylene group, or a biphenylylene group; and the hydrogen atom in the group represented by Ar¹ may be partially or totally substituted with a halogen atom, an alkyl group, or an aryl group.].

The liquid crystal polyester may further have a monomer unit represented by the following formula (II) (hereinafter also referred to as “monomer unit (II)”) and/or a monomer unit represented by the following formula (III) (hereinafter also referred to as “monomer unit (III)”):

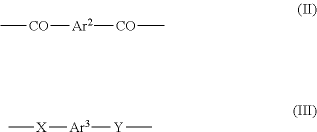

[wherein, Ar² and Ar³ each independently represents a phenylene group, a naphthylene group, a biphenylylene group, or a group represented by the following formula (IV). X and Y each independently represents an oxygen atom or an imino group (—NH—). For example, a hydrogen atom in the group represented by Ar² may be partially or totally substituted with a halogen atom, an alkyl group, or an aryl group. For example, a hydrogen atom in the group represented by Ar³ may be partially or totally substituted with a halogen atom, an alkyl group, or an aryl group.]

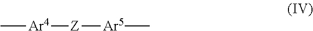

[wherein Ar⁴ and Ar⁵ each independently represents a phenylene group or a naphthylene group. Z represents an oxygen atom, a sulfur atom, a carbonyl group, a sulfonyl group, or an alkanediyl group.].

Examples of the halogen atom that can be substituted with the hydrogen atom in Ar¹, Ar², or Ar³ include a fluorine atom, a chlorine atom, a bromine atom, and an iodine atom.

The alkyl group that can be substituted with the hydrogen atom in Ar¹, Ar², or Ar³, may be linear, branched, or cyclic. The alkyl group may be, for example, an alkyl group having 1 to 10 carbon atoms. Examples of the alkyl group include a methyl group, an ethyl group, an n-propyl group, an isopropyl group, an n-butyl group, an isobutyl group, a s-butyl group, a t-butyl group, an n-hexyl group, a 2-ethylhexyl group, an n-octyl group, and an n-decyl group.

The aryl group that can be substituted with the hydrogen atom in Ar¹, Ar², or Ar³ may be a monocyclic ring and may be alternatively a fused ring. The aryl group may be, for example, an aryl group having 6 to 20 carbon atoms. Examples of the aryl group include a phenyl group, an o-tolyl group, a m-tolyl group, a p-tolyl group, a 1-naphthyl group, and a 2-naphthyl group. The aryl group may be a group in which a hydrogen atom on the aromatic ring is substituted with an alkyl group, such as a tolyl group.

In a case in which the hydrogen atom in Ar¹, Ar², or Ar³ is substituted with one of the groups described above, the number of substitutions may be one or two and may be alternatively one.

The alkanediyl group in Z may be linear or branched. The alkanediyl group may be an alkanediyl group having 1 to 10 carbon atoms. Examples of the alkanediyl group include a methylene group, an ethanediyl group, and a propanediyl group (for example, a propane-2,2-diyl group), a butanediyl group, an octanediyl group (for example, an octane-3,3-diyl group).

The monomer unit (I) may be, for example, a monomer unit in which Ar¹ is a phenylene group, a monomer unit in which Ar¹ is a naphthylene group, or a monomer unit in which Ar¹ is a biphenylylene group; it may be alternatively a monomer unit in which Ar¹ is a phenylene group or a monomer unit in which Ar¹ is a naphthylene group; and it may be alternatively a monomer unit in which Ar¹ is a 1,4-phenylene group or a monomer unit in which Ar¹ is a 2,6-naphthylene group. The liquid crystal polyester may have one or two or more of monomer units (I).

The monomer unit (II) may be, for example, a monomer unit in which Ar² is a phenylene group, a monomer unit in which Ar² is a naphthylene group, a monomer unit in which Ar² is a biphenylylene group, or a monomer unit in which Ar² is a diphenylether-diyl group; it may be alternatively a monomer unit in which Ar² is a phenylene group, a monomer unit in which Ar² is a naphthylene group, or a monomer unit in which Ar² is a biphenylylene group; and it may be alternatively a monomer unit in which Ar² is a phenylene group or a monomer unit in which Ar² is a naphthylene group. The phenylene group may be a 1,4-phenylene group or a 1,3-phenylene group. The naphthylene group may be a 2,6-naphthylene group or a 2,7-naphthylene group. The biphenylylene group may be a 4,4′-biphenylylene group. The diphenylether-diyl group may be a diphenylether-4,4′-diyl group. The liquid crystal polyester may alternatively have one or two or more monomer units (II).

The monomer unit (II) may be, for example, a monomer unit in which Ar² is a 1,4-phenylene group, a monomer unit in which Ar² is a 1,3-phenylene group, a monomer unit in which Ar² is a 2,6-naphthylene group, a monomer unit in which Ar² is a 2,7-naphthylene group, a monomer unit in which Ar² is a 4,4′-biphenylylene group, or a monomer unit in which Ar² is a diphenylether-4,4′-diyl group; and it may be alternatively a monomer unit in which Ar² is a 1,4-phenylene group, a monomer unit in which Ar² is a 1,3-phenylene group, or a monomer unit in which Ar² is a 2,6-naphthylene group.

The monomer unit (III) may be, for example, a monomer unit in which Ar³ is a phenylene group, a monomer unit in which Ar³ is a naphthylene group, or a monomer unit in which Ar³ is a biphenylylene group; it may be alternatively a monomer unit in which Ar³ is a phenylene group or a monomer unit in which Ar³ is a biphenylylene group; and it may be alternatively a monomer unit in which Ar³ is a 1,4-phenylene group or a monomer unit in which Ar³ is a 4,4′-biphenylylene group. The liquid crystal polyester may alternatively have one or two or more monomer unit (III).

The monomer unit (III) may be alternatively a monomer unit (III) in which X and Y are each an oxygen atom.

The monomer unit (I) may be a monomer unit represented by the following formula (Ia) (hereinafter also referred to as “monomer unit (Ia)”); the monomer unit (II) may be a monomer unit represented by the following formula (IIa) (hereinafter also referred to as “monomer unit (IIa)”), and the monomer unit (III) may be a monomer unit represented by the following formula (IIIa) (hereinafter also referred to as “monomer unit (IIIa)”):

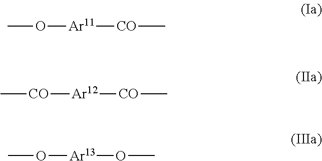

[wherein, Ar¹¹ represents a 1,4-phenylene group or a 2,6-naphthylene group; and Ar¹² represents a 1,4-phenylene group, a 1,3-phenylene group, a 2,6-naphthylene group, a 2,7-naphthylene group, a 4,4′-biphenylylene group, or a diphenylether-4,4′-diyl group.

Ar¹³ represents a 1,4-phenylene group or a 4,4′-biphenylylene group.

Alternatively, a hydrogen atom in the group represented by Ar¹¹, Ar¹², or Ar¹³ may each independently be partially or totally substituted with a halogen atom, an alkyl group having 1 to 10 carbon atoms, or an aryl group having 6 to 20 carbon atoms.].

The liquid crystal polyester may be, for example, a polymer having a monomer unit (Ia); it may be alternatively a polymer having a monomer unit (Ia) and a monomer unit (IIa); and it may be alternatively a polymer having a monomer unit (Ia), a monomer unit (IIa), and a monomer unit (IIIa).

The liquid crystal polyester preferably has a monomer unit derived from an aromatic hydroxycarboxylic acid (hereinafter also referred to as “monomer unit A”); a majority of the monomer units (for example, 50 mol % or more) may be alternatively the monomer unit A; and all of the monomer units may be alternatively the monomer units A.

The liquid crystal polyester may also have, as the monomer unit A, at least one monomer unit selected from the group consisting of a monomer unit derived from p-hydroxybenzoic acid and a monomer unit derived from 2-hydroxy-6-naphthoic acid.

The number of monomer units A in the liquid crystal polyester having a monomer unit A may be alternatively 20 mol % or more, 30 mol % or more, 40 mol or more, 50 mol % or more, 55 mol % or more, or 60 mol % or more, based on the total of all monomer units in the liquid crystal polyester. Also, the number of monomer units A in the liquid crystal polyester having a monomer unit A may be alternatively 100 mol % or less, 95 mol % or less, 90 mol % or less, 85 mol % or less, or 80 mol % or less, based on the total of all monomer units in the liquid crystal polyester.

That is, the number of monomer units A in the liquid crystal polyester having a monomer unit A may be, based on the total of all monomer units of the liquid crystal polyester, for example, 20 mol % or more and 100 mol % or less, 20 mol % or more and 95 mol % or less, 20 mol % or more and 90 mol % or less, 20 mol % or more and 85 mol % or less, 20 mol % or more and 80 mol % or less, 30 mol % or more and 100 mol % or less, 30 mol % or more and 95 mol % or less, 30 mol % or more and 90 mol % or less, 30 mol % or more and 85 mol % or less, 30 mol % or more and 80 mol % or less, 40 mol % or more and 100 mol % or less, 40 mol % or more and 95 mol % or less, 40 mol % or more and 90 mol % or less, 40 mol % or more and 85 mol % or less, 40 mol % or more and 80 mol % or less, 50 mol % or more and 100 mol % or less, 50 mol % or more and 95 mol % or less, 50 mol % or more and 90 mol % or less, 50 mol % or more and 85 mol % or less, 50 mol % or more and 80 mol % or less, 55 mol % or more and 100 mol % or less, 55 mol % or more and 95 mol % or less, 55 mol % or more and 90 mol % or less, 55 mol % or more and 85 mol % or less, 55 mol % or more and 80 mol % or less, 60 mol % or more and 100 mol % or less, 60 mol % or more and 95 mol % or less, 60 mol % or more and 90 mol % or less, 60 mol % or more and 85 mol % or less, or 60 mol % or more and 80 mol % or less.

When the liquid crystal polyester is a polymer having two or more monomer units (I), at least one of Ar¹ s in the monomer units (I) may be a naphthylene group. When the liquid crystal polyester is a polymer having a monomer unit (I) and a monomer unit (II), at least one of Ar¹s in the monomer units (I) and Ar²s in the monomer units (II) may be a naphthylene group. When the liquid crystal polyester is a polymer having a monomer unit (I), a monomer unit (II), and a monomer unit (III), at least one of Ar¹s in the monomer units (I), Ar²s in the monomer units (II), and Ar³s in the monomer units (III) may be a naphthylene group.

When the liquid crystal polyester has a monomer unit (I), a monomer unit (II), and a monomer unit (III), the number of monomer units (I) may be, for example, 30 mol % or more; and it may be alternatively 40 mol % or more, 45 mol % or more, 50 mol % or more, or 55 mol % or more, based on the total of all monomer units in the liquid crystal polyester. Also, when the liquid crystal polyester has a monomer unit (I), a monomer unit (II), and a monomer unit (III), the number of monomer units (I) may be, for example, 80% or less; and it may be alternatively 70% or less, based on the total of all monomer units in the liquid crystal polyester.

That is, when the liquid crystal polyester has a monomer unit (I), a monomer unit (II) and a monomer unit (III), the number of monomer units (I) may be, for example, 30 mol % or more and 80 mol % or less, 30 mols or more and 70 mol % or less, 40 mol % or more and 80 mol % or less, 40 mol % or more and 70 mol % or less, 45 mol % or more and 80 mol % or less, 45 mol % or more and 70 mol % or less, 50 mol % or more and 80 mol % or less, 50 mol % or more and 70 mol % or less, 55 mol % or more and 80 mol % or less, or 55 mol % or more and 70 mol % or less, based on the total of all monomer units of the liquid crystal polyester.

When the liquid crystal polyester has a monomer unit (I), a monomer unit (II), and a monomer unit (III), the number of monomer units (II) may be, for example, 35 mol % or less; and it may be alternatively 30 mol % or less, based on the total of all monomer units in the liquid crystal polyester. Also, when the liquid crystal polyester has a monomer unit (I), a monomer unit (II), and a monomer unit (III), the number of monomer units (II) may be, for example, 5 mol % or more; and it may be alternatively 10 mol % or more or 15 mol % or more, based on the total of all monomer units in the liquid crystal polyester.

That is, when the liquid crystal polyester has a monomer unit (I), a monomer unit (II), and a monomer unit (III), the number of monomer units (II) may be, for example, 5 mol % or more and 35 mol % or less, 5 mol % or more and 30 mol % or less, 10 mol % or more and 35 mol % or less, 10 mol % or more and 30 mol % or less, 15 mol % or more and 35 mol % or less, or 15 mol % or more and 30 mol % or less, based on the total of all monomer units in the liquid crystal polyester.

When the liquid crystal polyester has a monomer unit (I), a monomer unit (II), and a monomer unit (III), the number of monomer units (III) may be, for example, 35 mol % or less; and it may be alternatively 30 mol % or less, based on the total of all monomer units in the liquid crystal polyester. Also, when the liquid crystal polyester has a monomer unit (I), a monomer unit (II), and a monomer unit (III), the number of monomer units (III) may be, for example, 5 mol % or more; and it may be alternatively 10 mol % or more or 15 mol % or more, based on the total of all monomer units in the liquid crystal polyester.

Namely, when the liquid crystal polyester has a monomer unit (I), a monomer unit (II), and a monomer unit (III), the number of monomer units (III) may be, for example, 5 mol % or more and 35 mol % or less, 5 mol % or more and 30 mol % or less, 10 mol % or more and 35 mol % or less, 10 mol % or more and 30 mol % or less, 15 mol % or more and 35 mol % or less, or 15 mol % or more and 30 mol % or less, based on the total of all monomer units in the liquid crystal polyester.

When the liquid crystal polyester has a monomer unit (I), a monomer unit (II), and a monomer unit (III), the ratio of the number of monomer units (II) to the number of monomer units (III) ([number of monomer units (II)]/[number of monomer units (III)]) may be alternatively 0.9/1 to 1/0.9, 0.95/1 to 1/0.95, or 0.98/1 to 1/0.98.

The liquid crystal polyester may have a monomer unit other than the monomer unit (I), monomer unit (II), and monomer unit (III), and the number of the monomer units is preferably 10% or less, more preferably 5% or less, still more preferably 2% or less, even still more preferably 1% or less, and particularly preferably 0%, based on the total of all monomer units in the liquid crystal polyester.

In the present description, the number of respective monomer units that the liquid crystal polyester has is determined by the analytical method disclosed in Japanese Patent Laid-Open No. 2000-19168. Specifically, the liquid crystal polyester is depolymerized by reaction with a lower alcohol in a supercritical state, and the depolymerized product (the monomer from which each monomer unit is derived) undergoes quantification by liquid chromatography, to be able to calculate the number of respective monomer units based on the total monomer unit.

The liquid crystal polyester can be produced by polymerizing a raw material monomer corresponding to the monomer unit constituting the liquid crystal polyester. For example, it can be produced according to the method disclosed in Japanese Patent No. 6,439,027.

The content of the liquid crystal polyester based on the total pellet amount may be, for example, 60% by mass or more; and it may be alternatively 70% by mass or more or 80% by mass or more. Also, the content of the liquid crystal polyester based on the total pellet amount may be, for example, 95% by mass or less; and it may be alternatively 90% by mass or less or 88% by mass or less.

That is, the content of the liquid crystal polyester based on the total pellet amount, may be, for example, 60% by mass or more and 95% by mass or less, 60% by mass or more and 90% by mass or less, 60% by mass or more and 88% by mass or less, 70% by mass or more and 95% by mass or less, 70% by mass or more and 90% by mass or less, 70% by mass or more and 88% by mass or less, 80% by mass or more and 95% by mass or less, 80, by mass or more and 90% by mass or less, or 80% by mass or more and 88% by mass or less.

### (2) Fibrous Filler

The pellet includes a fibrous filler (A).

An example of the fibrous filler (A) includes a glass fiber. The proportion of the glass fiber in the fibrous filler (A) may be, for example, 90% by mass or more; and it may be alternatively 95% by mass or more, 99% by mass or more, or 100% by mass.

The proportion of a fibrous filler (A-1) with a fiber length of 50 μm or less, occupied in the fibrous filler (A) is 0.54 by mass or less; and it may be alternatively 0.3% by mass or less, 0.1% by mass or less, or 0.05% by mass or less.

The small amount of fibrous filler (A-1) with a fiber length of 50 μm or less facilitates a fibrous filler (A′) with a fiber length of more than 50 μm to be exposed on a surface of a molded product. The exposure of fibrous filler (A′) on the surface facilitates a gas component (particularly high-boiling point component) inside the molded product to be volatilized and discharged therefrom due to heating upon molding. Therefore, within the above range of the amount of fibrous filler (A-1) with a fiber length of 50 μm or less, the amount of gas generated in an elevated-temperature environment is more significantly inhibited. The proportion of the fibrous filler (A-1) with a fiber length of 50 μm or less, occupied in the fibrous filler (A) may be alternatively 0% by mass. Also, the fibrous filler (A) may contain a small amount of fibrous filler (A-1) with a fiber length of 50 μm or less, and in this case, the proportion of the fibrous filler (A-1) may be, for example, 0.001% by mass or more; and it may be alternatively 0.005% by mass or more or 0.01% by mass or more.

A number-average fiber length of the fibrous filler (A) may be, for example, 50 μm or more; and it may be alternatively 100 μm or more or 200 μm or more. This tends to increase the mechanical strength of a molded product.

Also, the number-average fiber length of the fibrous filler (A) may be, for example, 1,500 μm or less; and it may be alternatively 1,000 μm or less, or 500 μm or more, resulting in a tendency to improve the details filling property of a molded product.

A fiber length distribution of the fibrous filler (A) (the proportion of the fibrous filler (A-1), the proportion of the fibrous filler (A-2), the number-average fiber length) is measured using the following method.

### <Measurement of Fiber Length Distribution>

Four grams of pellets are heated at 600° C. for 4 hours to obtain ash content. The obtained ash content is dispersed in ethylene glycol to prepare a prepared slide, which is then observed under an optical microscope of 500 magnifications. Among the fibers that stay within a field of view (fibers with both ends within the field of view), a fiber length of a fiber having a length equal to or longer than its diameter is measured. Fiber lengths of 500 or more fibers are measured to determine the fiber length distribution.

The fiber diameter (monofilament diameter) of the fibrous filler (A) may be, for example, 5 μm or more; and it may be alternatively 6 μm or more or 9 μm or more. Also, the fiber diameter (monofilament diameter) of the fibrous filler (A) may be, for example, 17 μm or less; and it may be alternatively 15 μm or less or 12 μm or less. That is, the fiber diameter (monofilament diameter) of the fibrous filler (A) may be, for example, 5 μm or more and 17 μm or less, 5 μm or more and 15 μm or less, 5 μm or more and 12 μm or less, 6 μm or more and 17 μm or less, 6 μm or more and 15 μm or less, 6 μm or more and 12 μm or less, 9 μm or more and 17 μm or less, 9 μm or more and 15 μm or less, or 9 μm or more and 12 μm or less.

The content rate C₁ of the fibrous filler (A) based on the total pellet amount, may be, for example, 0.05 or more; and it may be alternatively 0.1 or more or 0.12 or more. Also, the content rate C₁ of the fibrous filler (A) based on the total pellet amount, may be, for example, 0.4 or less and it may be alternatively 0.35 or less, 0.3 or less, or 0.2 or less. The content rate C₁ of the fibrous filler (A) based on the total pellet amount, may be, for example, 0.05 or more and 0.4 or less; it may be alternatively 0.1 or more and 0.35 or less, 0.1 or more and 0.3 or less, 0.1 or more and 0.2 or less, 0.12 or more and 0.3 or less, 0.12 or more and 0.3 or less, or 0.12 or more and 0.2 or less.

The content rate C₁ of the fibrous filler (A) is measured by the following method.

### <Measurement of Content Rate C₁ of Fibrous Filler (A)>

Four grams of pellets are heated at 600° C. for 4 hours to obtain ash content. The ash content corresponding to the fibrous filler (A) is separated from the obtained ash content, if necessary, and the mass of the ash content corresponding to the fibrous filler (A) is measured. The content rate of the fibrous filler (A) is calculated from the obtained mass and the mass of the pellets used for ashing.

It is to be noted that in a case in which the amount of fibrous filler (A) compounded in the pellet has been known before use, the content rate of fibrous filler (A) can also be calculated from the compounded amount. The glass fiber to be used for producing a pellet usually also contains a binder, and the amount of binder can be estimated by measuring an ignition loss of the glass fiber. The ignition loss of the glass fiber can be measured in accordance with JIS R3420.

The ignition loss of the glass fiber (i.e., the amount of binder) may be alternatively 0.2% or more, 0.25% or more, or 0.3% or more, and 1% or less, 0.8% or less, or 0.5% or less, based on the total amount of glass fiber.

The pellet may contain one or two or more resins other than the liquid crystal polyester. Examples of the resin include a polyolefin, a cyclic polyolefin, polyvinyl chloride, a polysulfone, a (meth)acrylic resin, a polyphenylene ether resin, a polyacetal resin, a polyamide resin, an imide resin, a polystyrene resin, a cellulose resin, a polyether ether ketone resin, a fluororesin, a polycarbonate resin, and a thermosetting resin.

The pellet may contain one or two or more additives other than the fibrous filler. Examples of the additive include a filler, a colorant, a dispersant, a plasticizer, an antioxidant, a curing agent, a flame retardant, a heat stabilizer, an ultraviolet-ray absorber, an antistatic agent, a surfactant, a lubricant, and a mold release agent.

In the pellet of the present embodiment, the ratio (N₁/C₁) of the number of spots per unit area N₁ (/mm), which are derived from the fibrous filler (A) and observed in a cross section perpendicular to the extrusion direction of the pellet, to the content rate C₁ of the fibrous filler (A) is 3,500 or more, and may be, for example, 4,000 or more, 4,200 or more, or 4,500 or more. This more significantly enhances the above-described effects.

Also, the ratio (N₁/C₁) is 20,000 or less and may be, for example, 18,000 or less or 15,000 or less; and it may be alternatively 10,000 or less, 8,000 or less, or 6,000 or less. In this case, the fibrous filler (A) can be said to be further inhibited from being broken, as a result of which a resin tends to be less heat-damaged during melt-kneading, further reducing the amount of gas generated.

That is, the ratio (N₁/C₁) may be, for example, 3,500 or more and 20,000 or less, 3,500 or more and 18,000 or less, 3,500 or more and 15,000 or less, 3,500 or more and 10,000 or less, 3,500 or more and 8,000 or less, 3,500 or more and 6,000 or less, 4,000 or more and 20,000 or less, 4,000 or more and 18,000 or less, 4,000 or more and 15,000 or less, 4,000 or more and 10,000 or less, 4,000 or more and 8,000 or less, 4,000 or more and 6,000 or less, 4,200 or more and 20,000 or less, 4,200 or more and 18,000 or less, 4,200 or more and 15,000 or less, 4,200 or more and 10,000 or less, 4,200 or more and 8,000 or less, 4,200 or more and 6,000 or less, 4,500 or more and 20,000 or less, 4,500 or more and 18,000 or less, or 4,500 or more and 15,000 or less, 4,500 or more and 10,000 or less, 4,500 or more and 8,000 or less, or 4,500 or more and 6,000 or less.

The number N₁ is measured using the following method.

### <Measurement of Number N₁>

An X-ray CT image of a cross section of the pellet perpendicular to the extrusion direction upon melt-kneading is acquired under the following conditions. An image of an arbitrary cross section is binarized using the following image analysis conditions, and the number of spots corresponding to the fibrous filler (A) in the cross section is counted. It is to be noted that the extrusion direction upon melt-kneading can be determined by visually observing an appearance of the pellets.

### X-Ray CT Image Acquisition Conditions

Apparatus: Nano3DX (manufactured by Rigaku Corporation)
Image acquisition mode: Continuous Scan
Lens: 2160
Radiation source: Mo
Binning: 1
Exposure Time: 7 s
Number of images: 1,000
XD distance: 5 mm

### Image Analysis

Software used: Luzex AP (manufactured by NIRECO CORPORATION)
Binarization method: Binarization in an automatic mode according to a software manual attached.

It is to be noted that the average value of circle-equivalent diameter of the spots and the circle-equivalent diameter of the cross section of the pellet are also calculated from the image.

The size of the pellet in the present embodiment is not particularly limited. The length of the pellet in the extrusion direction may be, for example, 2.0 mm or more; and it may be alternatively 2.2 mm or more or 2.5 mm or more. The length of the pellet in the extrusion direction may be, for example, 8.0 mm or less; and it may be alternatively 6.0 mm or less or 4.0 mm or less.

The circle-equivalent diameter of a cross section perpendicular to the extrusion direction of the pellet may be, for example, 2 mm or more; and it may be Alternatively 2.2 mm or more or 2.5 mm or more. Also, the circle-equivalent diameter of a cross section perpendicular to the extrusion direction of the pellet may be, for example, 8 mm or less; and it may be alternatively 6 mm or less or 4 mm or less.

The pellet of the present embodiment may be produced, for example, by the following method.

### (Pellet Production Method)

The method for producing a pellet of the present embodiment may include the step of melt-kneading the liquid crystal polyester and a fibrous filler (hereinafter also referred to as a fibrous filler (a)) and forming the mixture to obtain a pellet.

In the above-described step, the mixture undergoes melt-kneading and forming so that the ratio (N₁/C₁) of the number of spots per unit area N₁ (/mm²), which are derived from the fibrous filler (A) and observed in a cross section perpendicular to the extrusion direction of the pellet, to the content rate C₁ of the fibrous filler (A) in the pellet is 3,500 or more and 20,000 or less.

The fibrous filler (a) may be, for example, a fiber bundle obtained by having bundled fibrous fillers with a binder.

An example of the step described above includes a method for feeding the fibrous filler (a) to a melt of the liquid crystal polyester, and kneading and extruding the mixture. Such a method enables, for example, prolonging a time from the feed of fibrous filler (a) to the melt of the liquid crystal polyester to the kneading (for example, by extending a length from an inlet of the fibrous filler to a kneading disc unit) and prolonging a kneading time (for example, by increasing a length of the kneading disc unit), allowing the binder that bundles the fibrous fillers together to decompose and generate volatile gas, which then loosens the fibrous fillers in the melt, making it less likely for an aggregate of the fibrous fillers to remain in the pellet.

When the liquid crystal polyester and the fibrous filler are kneaded, the fibrous filler compounded into the liquid crystal polyester may break, resulting in forming of fibrous filler with a short fiber length. In this case, when the fibrous filler is crushed rather than broken, a significantly shorter fibrous filler (A-1) is likely to be formed. Therefore, in the step above, selecting a method that minimizes crushing the fibrous filler facilitates a pellet containing the fibrous filler (A-1) in a proportion of 0.5% by mass or less to be obtained.

For example, prolonging a time from a feed of the fibrous filler (a) to a melt of the liquid crystal polyester to a kneading, tends to minimize crushing the fibrous filler. Prolonging a time from the feed to the kneading allows the fibrous fillers (a) to be loosened in the melt, as a result of which the fibrous filler (A-1) is inhibited from being formed due to the crushing of an aggregate of the fibrous fillers (a) (for example, a bundle of fibers adhered with a binder).

The step above may be carried out using, for example, a twin-screw extruder.

The pellet of the present embodiment is suitable for use in parts for telecommunications equipment, electrical equipment, electronic equipment, medical equipment, automobiles, home appliances, industrial machinery, and daily necessities. These parts can be produced by molding the pellets of the present embodiment using, for example, injection molding, compression molding, extrusion molding, blow molding, or the like.

All the above describes one embodiment of the invention disclosed herein, but the invention disclosed herein is not limited to the above embodiment.

### EXAMPLES

Hereinafter, the invention disclosed herein will be further specifically described with reference to Examples, but the invention disclosed herein is not limited to these Examples. In the Examples, a percentage and parts representing content or amount used are those by mass unless otherwise specified.

### Example 1

### (1) Production of Liquid Crystal Polyester

A reactor equipped with a stirrer, a torque meter, a nitrogen gas inlet tube, a thermometer, and a reflux condenser was charged with 1,118.8 g (8.10 mol) of p-hydroxybenzoic acid, 547.4 g (3.00 mol) of 2-hydroxy-6-naphthoic acid, 1,235.3 g (12.1 mol) of acetic anhydride, and 0.17 g of 1-methylimidazole. After having been thoroughly substituted with nitrogen gas, the reactor was raised to a temperature of 140° C. over 15 minutes under a nitrogen gas flow and maintained at 140° C. to carry out refluxing for 1 hour. The temperature was then raised to 280° C. over 3 hours and 40 minutes while acetic acid produced as a by-product was distilled off, and the reaction was considered complete when an increase in torque was observed, and the contents were removed. The flow starting temperature of the resulting solid content was 235° C. The resulting solid content was cooled to room temperature and pulverized using a coarse pulverizer. Under a nitrogen atmosphere, the temperature was raised from room temperature (25° C.) to 235° C. over 1 hour, then from 235° C. to 240° C. over 4 hours and 10 minutes, and maintained at 240° C. for 5 hours then to carry out solid-state polymerization. The resulting solid-state polymer was cooled to room temperature to obtain a powdered liquid crystal polyester (1). The flow starting temperature of the resulting liquid crystal polyester (1) was 277° C.

### (2) Production of Pellet

Using a twin-screw extruder (TEM48S manufactured by SHIBAURA MACHINE CO., LTD.), the liquid crystal polyester (1) and a glass fiber (ECS03T-786H, ignition loss: 0.35%, manufactured by Nippon Electric Glass Co., Ltd.) were kneaded to produce a pellet containing the liquid crystal polyester (1) and the glass fiber.

Specifically, the liquid crystal polyester (1) was fed through the main feed port of the twin-screw extruder, and the glass fiber was fed through a side feed port, the mixture was kneaded, and the kneaded product was then extruded from an extruder nozzle to obtain a strand. It is to be noted that the feed amounts were 85 parts by mass of the liquid crystal polyester (1) and 15 parts by mass of the glass fiber, respectively.

The strand was sprayed with water to cool and solidify it, and was next blown with air to further cool it, along with removal of water. The solidified strand was then cut using a pelletizer to obtain pellets containing the liquid crystal polyester (1) and the glass fiber.

### Comparative Example 1

A pellet containing the liquid crystal polyester (1) and a glass fiber was obtained in the same manner as in Example 1, except that the side feed port was moved downstream, the length from the side feed port to the kneading disc unit was set to 0.9 times that of Example 1, and the length of the kneading disc unit was set to 0.5 times that of Example 1.

### <Measurement of Content Rate C₁ of Fibrous Filler>

Four grams of pellets were heated at 600° C. for 4 hours to obtain ash content. The mass of the resulting ash content was measured to calculate the content rate C₁ of the fibrous filler from the obtained mass and the mass of the pellets used for ashing.

### <Measurement of Number N₁>

An X-ray CT image of a cross section of the pellet perpendicular to the extrusion direction upon melt-kneading was acquired under the following conditions. An image of an arbitrary cross section was binarized using the following image analysis conditions, and the number of spots corresponding to the fibrous filler (A) in the cross section was counted. Also, the average value of circle-equivalent diameter of the spots and the circle-equivalent diameter of the cross section of the pellet were measured from the above-described image.

### X-Ray CT Image Acquisition Conditions

Apparatus: Nano3DX (manufactured by Rigaku Corporation)
Image acquisition mode: Continuous Scan
Lens: 2160
Radiation source: Mo
Binning: 1
Exposure Time: 7 s
Number of images: 1,000
XD distance: 5 mm

### Image Analysis

Software used: Luzex AP (manufactured by NIRECO CORPORATION)
Binarization method: Binarization in an automatic mode according to a software manual attached.

TABLE 1

| | | Comparative |
|---|---|---|
| | Example 1 | Example 1 |
| Content rate C1 of fibrous filler (A) | 0.15 | 0.15 |
| Number of spots N1 (/mm2) | 743 | 477 |
| Ratio (N1/C1) | 4955 | 3181 |

### <Circular-Equivalent Diameter of Spot>

An average value of the circular-equivalent diameters of the spots was measured from the above-described image acquired by having measured the number N₁. As a result, the average value of the circular-equivalent diameters of the spots in Example 1 was 11.7 μm. The average value of the circular-equivalent diameters of spots in Comparative Example 1 was, on the other hand, 20.9 μm, indicating that the glass fiber in the pellet of Comparative Example 1 was not sufficiently opened.

### <Measurement of Fiber Length Distribution of Glass Fiber>

The fiber length distribution of the glass fiber in the pellets obtained in Example 1 and Comparative Example 1 was measured using the following method.

Four grams of pellets were heated at 600° C. for 4 hours to obtain ash content. The obtained ash content was dispersed in ethylene glycol to prepare a prepared slide, which was then observed under an optical microscope at 500 magnifications. Among the fibers that stayed within a field of view (fibers with both ends within the field of view), a fiber length of a fiber having a length equal to or longer than its diameter was measured. Fiber lengths of 500 or more fibers were measured to determine the fiber length distribution.

From the obtained fiber length distribution, the proportion of the fibrous filler (A-1) with a fiber length of 50 μm or less and the number-average fiber length of the fibrous filler were determined. The results are shown in Table 2.

TABLE 2

| | | Comparative |
|---|---|---|
| | Example 1 | Example 1 |
| Fibrous filler (A-1) (% by mass) | 0.046 | 2.6 |
| Number-average fiber length (Om) | 311 | 211 |

### <Evaluation of Amount of Gas Generated>

The amounts of gas generated of the pellets obtained in Example 1 and Comparative Example 1 were evaluated using the following method.

The pellet was used to fabricate a 0.8 mm thick dumbbell test piece by injection molding. The parallel portion of this test piece was cut into 5 mm squares to obtain a measurement sample of 5 mm×5 mm×0.8 mm. Four grams of the measurement sample was placed in a vial and sealed with a septum. The sample sealed in the vial was heated at 120° C. for 20 hours, and measured for the amount of gas generated using a headspace gas chromatograph (GC-2030AF manufactured by Shimadzu Corporation) under the following conditions.

### <Conditions>

Column: Rtx-1301 manufactured by Restek Corporation (inner diameter: 0.25 mm, length: 60 m, and film thickness: 1.4 μm)
Column temperature: The sample was held at 60° C. for 5 minutes, then raised to a temperature of 220° C. at 10° C./min, and held at 220° C. for 15 minutes.
Carrier gas: Helium
Split ratio: 10
Carrier gas flow rate: 10 mL/min

Acetone, acetic acid, phenol, and acetic phenol underwent quantification using a calibration curve, and peaks derived from other components underwent quantification in terms of acetone for a peak with the retention time of 15.5 minutes or shorter and in terms of phenol for a peak with the retention time of longer than 15.5 minutes, respectively. The measured amounts of low-boiling components with the retention time of 15.5 minutes or shorter and of high-boiling components with the retention time of longer than 15.5 minute are shown in Table 3.

TABLE 3

| | | Comparative |
|---|---|---|
| | Example 1 | Example 1 |
| Low-boiling components (ppm) | 0.2 | 0.4 |
| High-boiling components (ppm) | 3 | 4.5 |
| Total amount (ppm) | 3.2 | 4.9 |

As shown in Table 3, the pellet of Example 1 inhibited generation of the gas (particularly high-boiling components) in an elevated-temperature environment, compared to the pellet of Comparative Example 1.

1. A pellet comprising a liquid crystal polyester and a fibrous filler (A),
wherein a ratio (N₁/C₁) of the number of spots per unit area N₁ (/mm²), which are derived from the fibrous filler (A) and observed in a cross section perpendicular to the extrusion direction of the pellet, to a content rate C₁ of the fibrous filler (A) is 3,500 or more and 20,000 or less.

2. The pellet according to claim 1, wherein the content rate C₁ of the fibrous filler (A) is 0.05 or more and 0.4 or less.

3. The pellet according to claim 1, wherein an average value of circle-equivalent diameter of the spots is 9 μm or more and 13 μm or less.

4. The pellet according to claim 1, wherein the fibrous filler (A) comprises a glass fiber.

5. The pellet according to claim 1, wherein the liquid crystal polyester comprises a monomer unit derived from an aromatic hydroxycarboxylic acid.

6. The pellet according to claim 5, wherein a content of the monomer unit is 50 mol % or more, based on a total of all monomer units constituting the liquid crystal polyester.

7. A method for producing a pellet, comprising a step of melt-kneading a liquid crystal polyester and a fibrous filler and forming the mixture to obtain a pellet,
wherein the step is a step of carrying out the melt-kneading and forming so that a ratio (N₁/C₁) of the number of spots per unit area N₁ (/mm²), which are derived from the fibrous filler (A) and observed in a cross section perpendicular to the extrusion direction of the pellet, to a content rate C₁ of the fibrous filler (A) in the pellet is 3,500 or more and 20,000 or less.
